(19) United States
(12) Patent Application Publication
(10) Pub. No.: US 2023/0031817 A1
(43) Pub. Date: Feb. 2, 2023

(54) SYSTEM AND METHOD FOR AUTHENTICATING AND CERTIFYING A PHYSICAL ITEM, AND CORRESPONDING CERTIFIED PHYSICAL ITEM

(71) Applicants: Eleonora MULAS, Rivoli (Torino) (IT); Gabriele BERNASCONI, Bagno a Ripoli (Firenze) (IT); GENUINO BLOCKCHAIN TECHNOLOGIES S.R.L., Cagliari (IT)

(72) Inventors: Eleonora MULAS, Rivoli (Torino) (IT); Gabriele BERNASCONI, Bagno a Ripoli (Firenze) (IT); Davide MENINI, Sorso (Sassari) (IT); Francesco NOT, Mena - Cavazzo Carnico (Udine) (IT); Dan RUSNAC, Perugia (IT); Angelo PELLEGRINON, Lignano Sabbiadoro (Udine) (IT)

(21) Appl. No.: 17/791,103

(22) PCT Filed: Jan. 7, 2021
(86) PCT No.: PCT/IB2021/050093

§ 371 Date: Jul. 6, 2022

(30) Foreign Application Priority Data
Jan. 7, 2020 (IT) 102020000000091

(51) Int. Cl. G06Q 30/00; G06Q 20/20; G06K 7/10

(52) U.S. Cl. CPC G06Q 30/0185; G06Q 20/208; G06K 7/1097

(57) ABSTRACT

A system and a method for authenticating and certifying a physical item are provided. The system has an identification tag coupled to the physical item and having a relevant tag identifier adapted to be read at a distance, a non-fungible cryptographic token issued on a predetermined digital register distributed in a plurality of nodes of a processor network and configured to store the relevant tag identifier of the identification tag coupled to the physical item and data or information representative of the physical item, and detectors for detecting the presence of the identification tag of the physical item passing nearby a predetermined detection area or through a predetermined detection gate. Data indicative of the presence of the physical item in the predetermined area or the physical item passing through the predetermined gate is recorded in the non-fungible cryptographic token. The physical item may be a garment, a sportswear item, a collectible, or a luxury item.

This invention relates to the authentication and certification of goods, such as prestige goods or collectible goods, and specifically a system for authenticating and certifying a physical item according to the preamble of claim 1 and a corresponding method.

The phenomenon of counterfeiting is present in many sectors and widespread across electronic commerce channels. It affects goods of various kinds, from clothing items and accessories to consumer electronic products, of which copies that are similar in appearance to the original products and have a brand evocative thereof are sold on commercial channels.

In the case of collectible goods or luxury goods, the value of which is higher than that of consumer goods, the certification of a good as an original product, whose declared origin is authentic, is particularly important. Examples hereof are luxury goods such as jewelry made of precious materials, clothing from renowned brands, fine wines, or collectible goods, including not only objects intended to be collected as one of a predetermined number of specimens, but also items whose uniqueness lies in having been used on the occasion of specific events or in particular contexts. The latter case concerns, for example, haute couture garments worn during a fashion show, stage clothes worn during a theatrical performance, sports jerseys worn during a competition, and vintage cars that competed in an official competition.

As in many other sectors, counterfeiting is also present in the sports sector. The annual turnover of Amazon Italia in 2018 for the merchandising of soccer teams in Serie A of the Italian soccer championship was over 8 million euros, 5.5 million euros of which came from the match jerseys (68% of the total turnover). It is on digital platforms and on social media that the trade of more or less visibly counterfeit jerseys takes place. Interest among counterfeiters in this market may be directly linked to the value of “Match Worn” jerseys, i.e. the jerseys worn by the players in a specific match, which may reach and exceed the value of 500 euros per garment.

To cope with the problem of counterfeiting, it is necessary to adopt tools for tracing the item, from its production to its distribution through sales channels and to any transfers of ownership that may occur over time.

An identity authentication and verification system that makes it possible to assign and authenticate the identity of objects without relying on a third party authentication service is disclosed in international patent application WO2016/197055, which describes a system based on the use of radio-frequency tags that may be coupled to a product in a tamper-proof manner, and a database structure defined on a distributed register adapted to store an ownership history of the product.

Such a system is capable of certifying the authenticity of an item by tracing its change of ownership through the adoption of writings on an unalterable distributed digital register, such as a data structure known as blockchain.

The prior art, however, does not address the aspect of authenticating the uniqueness of an item that derives from the fact that it has been used on the occasion of a specific event or in a particular context.

This invention therefore aims to provide a satisfactory solution to the problems described above while avoiding the drawbacks of the prior art, and in particular it aims to provide a solution for the authentication and certification of a physical item used on the occasion of a specific event or in a particular context, by means of registration tools that are secure and unalterable, i.e. which are not exposed to fraudulent tampering.

In a currently preferred exemplary use for the authentication and certification of jerseys worn by players in a specific match (so-called “Match Worn” jerseys), this invention aims to record the basic information related to the jersey, including the match in which the jersey was worn, to guarantee the authenticity of the jersey in that it was worn during the match declared in the basic information, and to trace the creation and transfers of ownership of the jersey.

According to this invention, this aim is achieved by a system for authenticating and certifying a physical item having the features set out in claim 1, and by a method for authenticating and certifying a physical item having the features set out in claim 16.

Particular embodiments form the subject matter of the dependent claims, the content of which is to be understood as an integral part of this description.

A further subject of the invention is a certified physical item as claimed.

In summary, this invention is based on the principle of providing a unique digital representation of a physical item in the form of a non-fungible cryptographic token issued on a predetermined distributed digital register, such as a token according to the ERC721 standard issued, for example, on the Ethereum blockchain platform, and recording on said token not only the data representative of the item, but also a data element indicative of the presence of the item (for example the transit of the item) in a predetermined detection area or through a predetermined detection gate, which is located along an access path to an event during which the physical item is used, whereby the recording of the presence of the item in the predetermined detection area or through the predetermined detection gate is adapted to correlate the item to said event, i.e. to certify its use in the event.

One example of use is in the context of sports clothing, in particular with reference to the jerseys of athletes who have taken part in a competition, for example soccer players who have worn the jersey during a recognized match.

Each soccer jersey is in itself a product consisting of a blank jersey (i.e. anonymous and not associated with a player) plus a set of patches that may be applied via a heat press.

The jerseys are typically ordered from a technical supplier in the fall of the year preceding the season of use, and are supplied in early summer for use in the upcoming season, which typically begins in July. In the same period, the patches are ordered which bear the jersey numbers, the names of the players, the names of the sponsors, the team emblem and possibly the trophies won, integration of which is possible during the soccer season by virtue of the changes to the team as a result of the transfer market and player purchases.

Blank jerseys that arrive at a team's warehouse are provided with front patches (for the sponsor) before being stored.

In preparation for a soccer event, once the team of players who will take part has been received, the jerseys are assembled with the rear patches bearing the name of the player and the match number.

The jerseys prepared for an event become “Match Worn” jerseys, which are the jerseys worn and actually used on field during the game phase (typically two jerseys are used on field, one during the first half and one during the second half, one of which is left to the soccer team in order to be sold, and the other of which remains available to the player who wore it), and “Match Prepared” jerseys, which are the jerseys prepared and/or even worn but which were not actively used in the match for which they were prepared (these may be reused in a subsequent event if they have not been subjected to stress, for example from sweat).

In order to ensure that the aims of the invention are achieved, each jersey is uniquely identified both in the physical and in the digital world. To do this, an identification tag, for example a radio-frequency readable tag, and a graphic identification code of the item or an identification code of the item stored electronically according to a predetermined format, for example an NDEF format, is associated with the jersey. The identification tag is expediently a radio-frequency readable RFID tag coupled to a heat-pressable patch, and even more advantageously, instead of the identification tag, is an identification tag assembly comprising a combination of an RFID tag and an NFC tag, wherein one safeguards the authentication code of the other. The patch may be, for example, a patch of a certifying body or company inserted inside the jersey. The graphic identification code of the jersey is, for example, a barcode such as a two-dimensional barcode or QR code which, for example by means of a link generated by a computer system, represents at least part of the identifier code (serial code) programmed in the RFID tag or in the identification tag assembly. In a step during which the jerseys are prepared before the event, the patches to which the identification tag or the identification tag assembly is coupled are inserted into the jersey, and each jersey, the relative patch and the event in question are uniquely associated and recorded, for example by means of an application. Moreover, a corresponding non-funigble token (NFT) is created in a digital register distributed in a plurality of nodes of a public or private processor network (hereinafter in blockchain), for example a token produced according to the ERC721 standard, for example on the Ethereum blockchain platform, which token is adapted to store at least the identifier code of the tag and possibly data or information that are representative of the item with which the tag is associated, including public data and cryptographic private data. Lastly, on the way out of the tunnel that leads from the changing rooms to the field entrance, through which tunnel the players who are preparing to play the match have to pass, a barrier for detecting the RFID tags or the identification tag assembly on each jersey is installed, and associated processing means are provided in order to detect the presence of the recognized jersey by reading the relevant identifier code and to record the jersey entering the field (and therefore classify said jersey as a “match worn” jersey) in the corresponding token. The presence of the jersey is detected by means of a geolocalized and non-manipulable reader.

Since the main element on which the solution is based is the jersey, the operations involving this item, which are not all carried out in blockchain but also include intermediate operations carried out “off chain” to guarantee correct identification of the item and prevent the use of stolen tags or the cloning of serials, are described below.

The first owner of the item, after the supplier, is the sports club for which the jerseys are intended.

In anticipation of a match, the jerseys are prepared by pairing the identification tag or the RFID and NFC identification tag assembly, a graphic identification code of a patch and a unique secret code which may not be detected by the graphic code, all linked to a specific event, i.e. to a specific match. This operation takes place, for example, by means of a web platform of an entity that owns the authentication and certification system, which platform may be accessed in a traditional manner, for example by identifying oneself using a pair of knowledge factors, such as a username and password, and a possible second authentication factor. The operation is carried out, for example, by a registered operator of the sports club.

By means of this operation, the basic information used for the creation of the NFT token is recorded in a support database, and the status of the jersey is set to an initial “ready” status.

When the jersey passes through the barrier for detecting the RFID tags, or the identification tag assembly, which barrier is provided in the predetermined detection area or through the predetermined detection gate (in the following generally referred to as a “portal”), preliminary checks are carried out and actions are undertaken depending on the type of jersey detected. If, on the specific day, there are no events for which the jersey is intended, which is verified by means of a comparison with data that refer to the event and are stored in a computer system of a certification entity extraneous to the system, an anomaly is reported (for example, an anomaly message is sent to predetermined recipients with an indication of the time stamp of the time when the jersey was detected, the serial code of the detected jersey and the name of the player paired therewith). The status of the jersey changes to “alert” and, if not unlocked by an authorized operator, the jersey may not be processed further. In the event that an event is scheduled on the specific day, verified by means of a comparison with data stored in the computer system of the certification entity extraneous to the system, the following different cases are given following the detection of the identification tag of a jersey:
neutral jersey (first pass), for which the status of the jersey is updated to “prepared”;
jersey with “worn” or “prepared” status, for which no action is taken;
tags are detected which are not present in the database, which may be tags of other non-relevant objects, but the intercepted serial codes may be recorded for subsequent consultation and verification.

At the end of the match, it is possible to process the jerseys that participated in the event, again by means of the web platform of the entity that owns the authentication and certification system. The data recorded in the support database are verified against the data available in the computer system of the certification entity extraneous to the system (for example, in the case of soccer matches, by means of the programming interface of the Livescore application from LiveSport Media Ltd). From the comparison, the authentication and certification system composes an association grid between the serial codes of the prepared jerseys, the serial codes of the RFID tags or of the identification tag assembly intercepted in the detection area or gate, the list of potentially “worn” jerseys and the list of potentially “prepared” jerseys. The operator may make any corrections, if necessary, and then the generation of digital NFT tokens is started. In an alternative and currently preferred embodiment, the digital tokens are created in advance, at the time when the patch with which an identification tag assembly is associated is created, and are subsequently populated with the data, including the association with the jersey, which therefore constitute subsequent tracking steps recorded in the token.

It is only possible to sell the jerseys after the match and the process of creating the NFT tokens representative of said jerseys have concluded. Generally, this may be done through two channels: the soccer club's marketplace (generally via e-commerce) or official retailers (physical point of sale).

When the tokens are generated, the first owner of the jersey is assigned, which owner may be the player, the club or the official retailer.

Again by means of the web platform of the entity that owns the authentication and certification system, it is possible to record a transfer of ownership (a transaction) between the club/the official retailer and a collector buyer on the token, for example according to the methods of digitally recording the fulfilment of a contract through ad hoc computer protocols (“smart contract”). In this case where the token is issued on the Ethereum blockchain platform, the buyer has an Ethereum wallet, the seeds and private keys of which remain at their disposal, which wallet contains the ERC721 token representative of the bought physical item. The transfer of ownership of the jersey takes place as a normal transaction on an Ethereum wallet, by transferring the NFT token from one wallet to another.

The verification of the authenticity of the jersey is an operation that may be performed by means of a user interface computer environment which is implemented as an application adapted to be downloaded and to reside on a user's personal mobile telecommunication device or on a user's personal processing device, which computer environment is designed to perform partial read access to the data recorded in the token on the basis of address data of the distributed digital register, such as the data stored in the graphic identification code of the item or in the identification code of the item stored electronically according to the predetermined format. This code may be expediently incorporated on the patch bearing the identification tag or available elsewhere in association with the jersey.

By means of the read code, the application verifies if the code is present in the support database, and, if this is the case, verifies if the corresponding record is paired with a token, to whom it belongs and where it is geolocated. A message informs the user of the status of the jersey paired with the read serial code.

Further features and advantages of the invention will be explained in greater detail in the following detailed description of an embodiment thereof, given by way of non-limiting example and with reference to the accompanying drawings, in which:

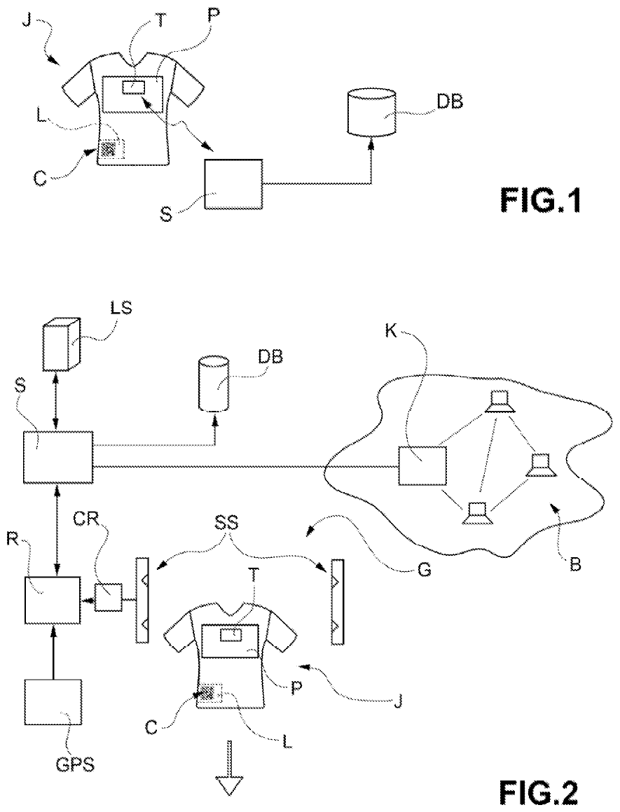

FIGS. 1, 2 and 3 are schematic views of a system for authenticating and certifying a physical item that is the subject of the invention, respectively in a step of initializing a physical item, a step of detecting the item in association with a predetermined event, and a step of consulting the record associated with an item; and

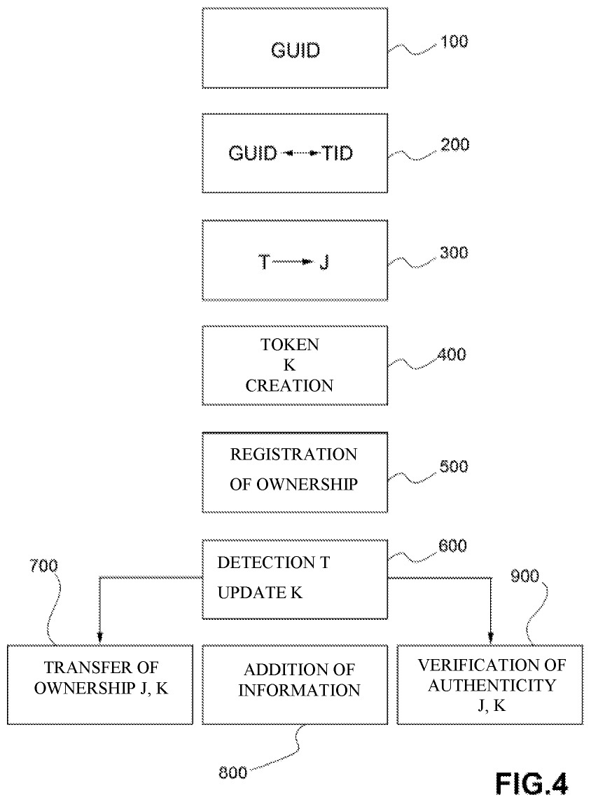

FIG. 4 is a flow diagram of the operations for authenticating and certifying a physical item, which operations are carried out by the system in FIGS. 1 to 3.

With reference to FIGS. 1 to 3, a system for authenticating and certifying a physical item is shown, in which the item is depicted, purely by way of non-limiting example of the invention, as a sports jersey J.

The complete jersey J, which is ready to be worn in a competition, bears a patch P adapted to show an inscription such as the name or number of the athlete, or a sponsor of the sports club or even an emblem or other inscription. The patch is made in such a way as to subsequently adhere to the jersey, for example by means of a thermostamping or heat-sealing technique which does not allow its removal, as otherwise said jersey will be damaged. An identification tag T having a relevant tag identifier adapted to be read at a distance, for example a radio-frequency readable RFID tag, is incorporated into the patch P in a tamper-proof manner, or the tag T is incorporated between the patch and the fabric of the jersey when the patch is coupled to the jersey. The identification tag T is preferably designed as a tracking and anti-counterfeiting element paired to the jersey such that it may not be separated from the jersey without one or the other being damaged, the element being provided with an integrated passive or active microcircuit (RFID, NFC, etc.) that may be programmed with a unique identifier, UID, that allows remote contactless acquisition. In a preferred embodiment, the identification tag T is provided with both RFID and NFC microcircuits, so that it may be intercepted by a short- and/or long-distance reader. Advantageously, the RFID microcircuit also stores the unique identifier of the NFC microcircuit, and vice versa, the NFC microcircuit also stores the unique identifier of the RFID microcircuit. The patch comprises a silicone body containing the RFID and NFC microcircuits, and the fact that each microcircuit contains the identifier of the other makes any possible manipulation, tampering or fraudulent reproduction operation more complex.

The jersey J also bears a labelling tag L which is coupled to the patch P or to the jersey J and which bears an identification code C of the item, such as a graphic barcode and preferably a two-dimensional barcode or QR code, or an identification code of the item stored electronically according to a predetermined format, for example the NDEF format in a circuit accessible by reading at radiofrequency in close proximity by means of an NFC protocol. The identification code C stores data including a unique identifier code of the item by means of which it is possible to trace the tag T and the token associated therewith.

A remote processing system S, such as a web platform of an entity that owns the authentication and certification system, is designed to have read access to the identification tag T and to record the relevant identifier in a support database DB, together with other data such as data or information representative of the jersey, the name of the athlete to whom the jersey is assigned and the competition in which the jersey will be used, which data may be provided to the system S through other input means, for example a touch-sensitive keyboard or graphical user interface.

FIG. 2 shows a portal G, which represents a predetermined detection gate located along an access path to the event during which the jersey is used, for example a predetermined transit area toward the playing field, through which area the jersey has to pass in order to be classified as an authentic item. One or more detectors SS are associated with the portal G, which detectors are adapted to detect the presence of an identification tag T of a jersey J passing nearby and to read the identifier of the tag.

In a currently preferred embodiment, the portal G consists of a supporting structure of suitable shape and size to allow the worn shirt, and more generally the physical item to be detected thereby, to pass through. The detectors SS, in the form of antennas or optical readers, are arranged along the internal perimeter of the portal or at certain points thereof and are capable of interacting with the tags T integrated in the jerseys and reading the identifiers thereof. The detectors SS are managed by a centralized reading system CR which decodes the data read therefrom and makes said data usable for subsequent processing. The detectors SS are designed so as to ensure that any tampering is detectable; for example, they are provided with at least one microswitch or internal circuit configured to be corrupted or damaged in the event of any tampering with the detector structure. The provision of a suitable microprocessor would also allow the moment of any tampering with the detectors to be tracked, the event to be recorded in a memory, and an alarm message to be sent. The centralized reading system CR is also designed so as to ensure that any tampering is detectable; for example, the operating system is integrated therein and is protected from unauthorized access by hardware encryption, and is provided with a unique identifier and technologies for authenticating the origin of the data. The centralized reading system CR is connected to a local processing unit R by means of a wired connection or radio wave connection (for example according to a Wi-Fi, GPRS, 3G, 4G or 5G protocol). In the preferred embodiment, in which the identification tag T is provided with both RFID and NFC microcircuits, a single long-range reader operating according to RFID technology or a single short-range reader operating according to NFC protocol may alternatively read the tag identifier, or a dual-technology reader (combined RFID and NFC technology) may intercept a tag at short range by means of both technologies, ensuring double verification of the tag identifier and therefore a higher level of security.

The portal G is advantageously provided with a multiple-input power supply device provided with rechargeable accumulators (batteries), which supply device is capable of supplying power to the detectors SS and to the centralized reading system CR even when the portal may not be connected to a permanent external power source. The accumulators may be recharged when the system is connected to an external power source (for example the electrical grid) or by alternative energy sources such as photovoltaic panels. The power supply device takes energy from the main source (electrical grid) and ensures that all the detectors and the centralized reading system are suitably supplied with energy in a form suitable for each one (regulation), and supports their operation even when disconnected from the electrical grid by allowing them to be used in remote environments or on the move by means of using rechargeable accumulators. It also allows the system to be powered and the accumulators to be recharged from secondary energy sources such as photovoltaic panels, wind systems, alternators/generators and more.

In an alternative embodiment, the predetermined area or gate for detecting the presence of the item and its access to the event may be defined by means of a virtual perimeter associated with a real geographic area (geo-fencing), which perimeter is dynamically generated or defined by a set of boundaries pre-established by means of terminals which are capable of determining the position thereof and provided with communication capabilities.

The processing unit R associated with the detectors SS is connected to the remote processing system S, for example by means of a global public computer network (Internet), to which it transfers data regarding the detection of the presence of the jerseys that have passed nearby to the portal G, which the remote processing system S stores in the database DB. The processing unit R is expediently a local processing device connected to the centralized reading system CR and therefore to the detectors SS, with protection against tampering and advanced data protection features (such as encryption, secure boot, etc.).

The remote processing system S is also designed to create a non-fungible cryptographic token, NFT, on a predetermined digital register B distributed in a plurality of nodes of a public or private processor network, storing therein a time stamp indicative of the time of creation of the token, the identifier of the tag T, the serial code of the jersey J or its patch P to which the tag T is coupled, any initialization data identifying the manufacturer of the jersey and a data item indicative of the presence of the jersey through the portal G, whereby the token, indicated by reference sign K in the figures, forms a unique digital representation of the jersey. In the case where RFID and NFC technology are both present in the tag, the processing system S stores the unique identifier of the NFC microcircuit in the token associated with the RFID identifier of the tag and, vice versa, stores the unique identifier of the RFID microcircuit in the token associated with the NFC identifier of the tag. The recording of the jersey passing through the portal G correlates the jersey to the event for which it is used.

Similarly, the jersey passing through the portal G may be recorded at the end of the event.

In the preferred embodiment, the distributed digital register is the Ethereum blockchain platform and the non-fungible token, NFT, is produced as a token according to the ERC721 standard on the Ethereum blockchain platform.

The remote processing system S is also designed to access the token K on the basis of the identifier acquired from the tag T of each jersey recorded in the database DB for which passage through the portal G has been recorded, in order to record therein data (public and private encrypted data) representative of transfers of ownership of the jersey, including at least one transfer of ownership from the manufacturer to a first buyer, which may be the sports club to which the jersey belongs or an official retailer thereof. Similarly, the remote processing system S may record on the token K data indicative of the current location of the jersey, at the first detection of transit through the portal G and subsequently by the owner of the token on a voluntary basis.

In an alternative embodiment, the local processing unit R is designed to record data directly on the token K in blockchain, without using the remote processing system S.

The processing unit R associated with the detectors SS is advantageously connected to a geographic localization system GPS designed for the localization of the detectors SS in a predetermined geographic reference system. The geolocation system GPS may also be integrated in the processing unit R or otherwise connected thereto so that any tampering with the system or the data acquired thereby that compromises its correct functioning may be detected.

In one embodiment, the geographic localization system GPS comprises satellite localization means (operating technologies according to GPS, GNSS, Galileo, etc.), and the processing unit R is designed to acquire data from the satellite devices used for localization, for example including respective identification codes and position coordinates, and to provide said data from the satellite devices to the remote processing system S in order to be recorded in the token K. In an alternative embodiment, the geographic localization system GPS comprises terrestrial localization means (for example, telephone cells, radio triangulation systems, etc.), and the processing unit R is designed to acquire data from the terrestrial devices used for localization, for example including respective identification codes and position coordinates, and to provide said data from the terrestrial devices to the remote processing system S in order to be recorded in the token K. The geographic localization system GPS is designed in such a way as to ensure that any tampering is detectable, is provided with a unique identifier and technologies for authenticating the origin of the data, and is connected to the processing unit R via a digital wired connection, while the remote processing system S manages its operations entirely.

The identification codes of the satellite or terrestrial devices used for localization are advantageously used by the remote processing system S to verify the origin of the data relating to the jerseys J acquired by the detectors SS, for example for comparison with external public databases.

In a currently preferred embodiment, the remote processing system S verifies the correlation of the jersey J to the event by means of a comparison with data which refer to the event and are stored in a computer system of a certification entity extraneous to the system, which entity is indicated by reference sign LS in FIG. 2.

Each connection or communication protocol, whether wired or wireless, advantageously has advanced features for protection, authentication and encryption of the transmitted data.

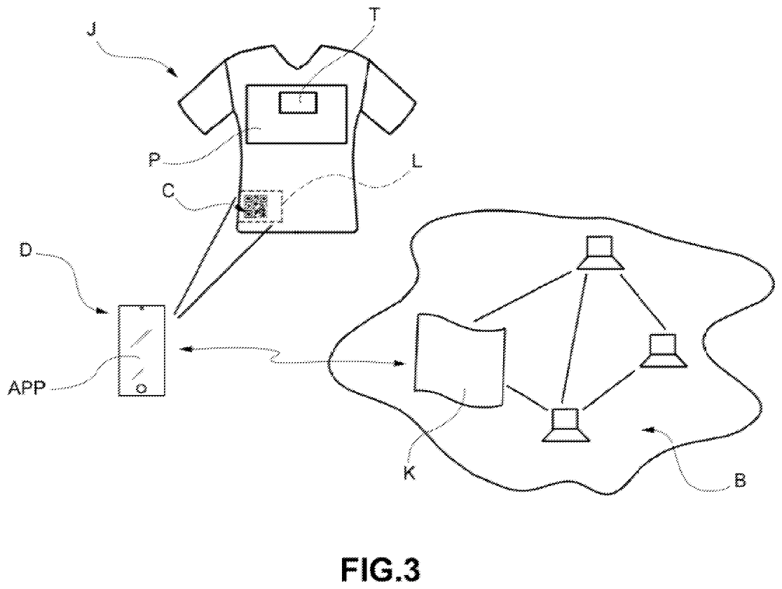

FIG. 3 shows a user interface computer environment, APP, implemented as an application adapted to be downloaded and to reside on a user's personal mobile telecommunication device D or on a user's personal processing device, and said computer environment is designed to perform partial read access to the data recorded in the token K on the basis of the address data obtainable from the identification code C of the item, for example to read identification data of the jersey and its current owner.

With reference to FIG. 4, an exemplary method for authenticating and certifying a physical item, such as an item of sportswear or a jersey J, is described below, which method comprises concisely the operations of:
generating a unique code for the item, GUID, in step 100;
pairing the unique code GUID of the item with the identifier TID of the tag T in step 200;
uniquely and physically associating the tag T with the item J in step 300;
digitalizing the item in blockchain in step 400, specifically by means of creating an associated token, according to one possible embodiment of the invention in which the token is created in advance;
recording the ownership of the item in blockchain in step 500;
detecting the presence (for example the transit) of the item through an area or a gate for reading the tag with (in one alternative embodiment, possibly creating the token if this has not occurred in step 400 and) recording in the token in blockchain in step 600;
registering a transfer of ownership in step 700;
adding supply chain steps of the item in blockchain in step 800; and
verifying the authenticity of the item in step 900.
The relevant steps of the method that is the subject of the invention are, in particular, coupling an identification tag having a relevant identifier adapted to be read at a distance to the item, issuing a non-fungible cryptographic token on a predetermined digital register distributed in a plurality of nodes of a public or private processor network, and storing the tag identifier in the token, detecting the tag of an item in transit in a predetermined detection area or through a predetermined detection gate with associated reading of the tag identifier, and recording, in the token associated with the tag identifier, a data element indicative of the presence of the item in the predetermined detection area or through the predetermined detection gate.

The steps of the method are described in detail in the following.

In step 100, the unique code of the item, or serial code, GUID, is generated by the remote processing system S, i.e. by the web platform of an entity that owns the authentication and certification system, and is intended to be associated with a single identification tag; said code may be revoked if the item is destroyed or if the item is removed from the platform, and may no longer be reused. This serial code also constitutes an identification code of the item for subsequent searching through user interface computer environments by constructing a URL (Uniform Resource Locator) that contains it. The URL is indelibly marked on the item by means of appropriate marking methods that allow it to be optically read (if it is marked in a barcode, QR code or similar) or is included in a predetermined digital format, for example the NDEF format (NFC Data Exchange Format), in a microcircuit for remote reading, for example via NFC protocol.

In step 200, two methods for initializing the identification tag are possible, according to currently preferred alternative embodiments.

A first possible initialization method involves pre-assigning the GUID.

In step 200, the identification tag integrated in the item to be traced is labelled by a unique code, UID, consisting of a non-modifiable and proprietary part of the tag, the identifier TID, and a second part containing a code MINIGUID uniquely paired with the identification tag. During the initialization step, the identifier TID and the code MINIGUID are read by a unique code of the item, or serial code, GUID, which represents its guarantee of authenticity. The MINIGUID is written on the tag, for example by means of an RFID or NFC writing system if the tag is provided with an active/passive electronic microcircuit that is readable using one of the aforementioned protocols, and the tag is subsequently locked by means of a randomly generated access password or by irreversibly configuring the write lock parameters, thus preventing the tag from being reprogrammed.

The identifier TID of the tag is read by an RFID/NFC reader device and sent to the remote processing system S in order to verify the presence of the tag data. If this is the case, the remote system S responds by communicating the code MINIGUID to be programmed inside the identification tag and the code GUID to be included in the optical identification system (for example QR code), which is then printed. The remote system S unmarks the tag as “processed.” The QR code is subsequently paired to the jersey J by means of the remote processing system S. The code MINIGUID of the tag is not used by the remote processing system S for the functionalities offered to a user, but may be used for counterchecking if there are disputes over the authenticity of the item associated with the tag.

At the end of the initialization method, there are the following elements:
identification tag comprising unique code UID composed of the tag identifier TID and the unique code MINIGUID;
an optical or NFC reading element which represents a URL containing the unique code of the tag GUID; and
an entry in the database DB maintained by the remote processing system S that associates the unique code of the tag GUID and the code MINGUID with the identifier TID.

In the currently preferred embodiment in which the patch is associated with an identification tag assembly comprising both an RFID microcircuit and an NFC microcircuit, the following NFC tag writing operations are performed to ascertain the authenticity of said tag.

An encrypted, password-protected and non-clonable message is written into the NFC microcircuit.

The entity that owns the authentication and certification system has two private keys which are saved in the database DB and used for the creation of appMasterKeys and appKeys.

Each NFC tag requires the following contents:
an AppMasterKey: a root password used to modify other passwords and set permissions;
a plurality of appKeys: passwords used to access a specific space of the memory in the microcircuit.

A registered operator of the sports club, by means of an application, reads the NFC tag and checks whether or not the tag has already been initialized. If the tag has not been initialized, the application makes a call to a backend system of the authentication and certification system by passing the serial code of the tag to said system. The backend system takes a first private key and concatenates the serial code of the tag to the key, and then hashes the result, and the resulting hash is the AppMasterKey of that tag. Then, the backend system takes the second private key and concatenates the serial code of the tag to the key, and then hashes the result, and the resulting hash is the AppKey. The backend system takes the serial code of the tag and concatenates a “GENUINO” (constant) string thereto. This is the content to be inserted into the tag, encrypted using the previously generated AppKey.

The backend system returns the AppMasterKey, the AppKey and the encrypted message to the application, and the application (in three different steps) must:
write the AppMasterKey in the tag and log out;
log in using the AppMasterKey and save the AppKey in the tag (for all the spaces provided in the memory of the microcircuit), and then log out;
log in using AppKey and write the encrypted message.

A second possible initialization method involves assigning the MINIGUID and pairing the GUID.

In step 200, the identification tag integrated in the item to be traced is labelled by a unique code, UID, consisting of a non-modifiable and proprietary part of the tag, the identifier TID, and a second part containing a code MINIGUID uniquely paired with the identification tag. During the initialization step, the identifier TID and the code MINIGUID are read by a unique code of the item, or serial code, GUID, which represents its guarantee of authenticity. The MINIGUID is written on the tag, for example by means of an RFID or NFC writing system if the tag is provided with an active/passive electronic microcircuit that is readable using one of the aforementioned protocols, and the tag is subsequently locked by means of a randomly generated access password or by irreversibly configuring the write lock parameters, thus preventing the tag from being reprogrammed.

The identifier TID of the tag is read by an RFID/NFC reader device and sent to the remote processing system S in order to verify the presence of the tag data. If this is the case, the remote system S responds by communicating the code MINIGUID to be programmed inside the identification tag. Using an optical reader, a local system reads the URL contained in a QR code from said QR code, extracting therefrom a previously printed code GUID. The extracted code and the identifier TID are sent to the remote system S which uniquely pairs them. The code MINIGUID of the tag is not used by the remote processing system S for the functionalities offered to a user, but may be used for counterchecking if there are disputes over the authenticity of the item associated with the tag.

At the end of the initialization method, there are the following elements:
identification tag comprising unique code UID composed of the tag identifier TID and the unique code MINIGUID;
an optical or NFC reading element which represents a URL containing the unique code of the tag GUID; and
an entry in the database DB maintained by the remote processing system S that associates the unique code of the tag GUID and the code MINGUID with the identifier TID.

Step 300 includes physically applying the previously prepared tag to the item and, by means of a computer system, the unique code of the tag is linked to the unique code of the item to be traced.

In step 400, the item thus identified and connected to the relative tag is generated in digital format on blockchain (token) with a further unique, non-modifiable identification code of the relative digital identity. Additional process information may be linked to this digital identity. The token contains any other serial codes of the components of the item, thus becoming a digital twin of the physical item in question.

In step 500, the item recorded in blockchain is automatically paired to the manufacturer of the physical item, who holds initial ownership thereof.

In step 600, the item passing through a portal for reading the identification tag at radiofrequency is detected by means of the emission of an excitation and reading carrier wave by the detectors SS associated with the portal, respectively a UHF carrier wave in the case of reading an RFID tag or an HF carrier wave in the case of reading an NFC tag. In the preferred embodiment in which the identification tag T is provided with both RFID and NFC microcircuits, the transit of the item may alternatively be detected at a long range (according to RFID technology) or at a short range (according to the NFC protocol), and in the latter case detection may take place using the double technology combining RFID and NFC, thereby guaranteeing double verification of the tag identifier and therefore a higher level of security. When passing through the electromagnetic field generated by the detectors SS, the tag is activated by transmitting its unique identification code, UID. Alternatively, it is possible to optically read the tag; if said tag is a passive tag without a microcircuit and is exposed outside the item, the detectors SS emit a beam of light to illuminate the code printed on the item which will then be read optically.

The detectors SS transmit the data regarding the presence of the detected tag to the centralized reading system CR which decodes the data, thereby making said data usable for subsequent processing. These data are encapsulated in a packet that contains the unique identifier of the centralized reading system CR. The data packet is in turn signed to allow the recipient to guarantee its origin and integrity.

The geolocation system GPS is adapted to detect the position of the portal and to prepare a data packet also containing the data of the devices used for localization, such as the visible GPS/GNSS/Galileo satellites or the GSM/5G radio links used for triangulation. The data packet formed in this way is signed to guarantee its origin and integrity.

The local processing unit R receives the data packet signed by the centralized reading system CR and by the geolocation system GPS, verifies its origin and integrity and, if these checks are positive, extracts the unique identification code, UID, of the tag and the position data, packing them together and signing the data packet thus obtained with its own certificate of origin. The data thus formed may follow two channels:
said data may be transmitted to the remote processing system S, which verifies its origin and integrity, extracts the relevant data therefrom and publishes said data on the blockchain;
said data may be published directly in blockchain by using a dedicated derived smart-contract.

The step 700 of recording a transfer of ownership may take place subsequently, at any time which is not related to the time of the previous steps being carried out but is triggered by the event of ownership of the item being transferred.

When the item is purchased by a customer, both the product and the token associated therewith are sent to the customer. From that moment on, the customer has full control over the token and is the only owner able to make changes. In particular, the customer may at any time update the position of the product, disable or enable the transfer of the digital twin or transfer it to third parties, preferably without being previously authorized and without the need to use intermediaries.

During the life cycle of the product, it is possible, as identified in step 800, to add the steps of the supply chain, i.e. the manufacturing processes or the addition of information, in blockchain. A movement is added to the history of the item by means of a specific function of the smart-contract. Each movement requires that the geolocation of the event and its time stamp are recorded. The information is made available in private or public form as appropriate, and may be accessed via blockchain.

Finally, the operation of verifying the authenticity of the item in step 900 takes place by means of various possible geolocation operations, by comparing against API and by reading in blockchain.

A verification operation may be performed through the user interface computer environment even without authentication, by a caller (subject interested in the verification), for example by framing the printed barcode paired with the tag. By means of the read code, the application associated with the interface computer environment verifies if the code is present in the database DB of the remote processing system, if the code is paired with a token identifier, if the token identifier exists, to whom it belongs and where it is geolocated (place). A suitable message warns the caller of the status of the product paired with the read serial code. In the event of an anomaly (the code exists but has not yet been put on sale or the code has been deactivated in advance, or the item was scanned in a place different from where the item should be), a report will be sent to the owner of the item in addition to the message. The application associated with the interface computer environment also verifies that the identification codes of the identification tag associated with the read code correspond in the archives of the entity that owns the authentication and certification system and in the distributed register.

In the currently preferred embodiment in which the identification tag comprises an RFID microcircuit and an NFC microcircuit, the authenticity of the tag is verified as follows:
the serial code of the tag is read and sent to the backend system, asking for the AppKey in return to access the private content of the memory. An AUTH KEY is used, which is to be inserted into the headers of the call, in order to ensure that only the devices/app of the certifying entity may receive the AppKey in return;
the backend system checks the validity of the AUTH KEY and searches for the serial code in the database, and then returns the AppKey;
the microcircuit is interrogated again by the frontend system with a request for the private content, and this is sent to the backend system, asking for the validity of this content;
the backend system decrypts the content and verifies that the result is equal to the serial code+“GENUINO” and returns “true” or “false” to the frontend system;
the frontend system shows on the application that the tag is authentic or not, depending on the “true” or “false” indication received.

Subsequently, using this information, it is verified whether a token in blockchain is associated with this tag, whether the token is marked as valid or not, whether the token is marked as “match worn” or “match prepared,” and this information is communicated to the final user.

Specifically, the verification of authenticity by means of geolocation is based on the verification of correspondence between the caller's longitude and latitude (obtained from the application of the caller's mobile device, possibly by consulting the existing databases of the identification codes of the issuing stations, for example the identifiers of the satellites in the case of the GPS/GNSS/Galileo localization system or GSM/5G radio stations in the case of the terrestrial localization system) and the current longitude and latitude of the item being verified (reading the data from the blockchain).

The verification of the ownership of the item is based instead on the use of the blockchain. For example, the current owner of the item may be verified by the owner themselves by verifying the presence of the item in their digital wallet, or by a so-called caller comparing the current owner of the item with the owner reported by the caller, through an exchange of encrypted messages by two digital wallets, i.e. a message request for confirmation of possession issued by the caller's digital wallet that requires verification and an expression of confirmation to the digital wallet that owns the item.

In this step, it is possible to remotely verify who is the owner of an item by reading the barcode associated with the item even if presented in digital format (image reproduced electronically). In this case, the interface application sends a message to the owner of the item asking him to send a signed message via blockchain to the requester. The owner of the item identified through a link contained in the read code may, through the application, report a violation or confirm ownership of the item by sending the requested signed message. The requester receives the ownership confirmation message or, otherwise, an anomaly message.

It should be noted that the embodiment proposed for this invention in the foregoing discussion is purely a non-limiting example of this invention. A person skilled in the art will easily be able to implement this invention in different embodiments which do not however depart from the principles set forth herein and are therefore encompassed in this patent.

This is particularly true with regard to the possibility of applying this invention to the authentication and certification of items other than items of sportswear, for example to other types of clothing, to collectible items or to luxury goods.

Naturally, without prejudice to the principle of the invention, the embodiments and the details of execution may vary widely with respect to that which has been described and illustrated purely by way of non-limiting example, without thereby departing from the scope of protection of the invention defined by the appended claims.

1. A system for authenticating and certifying a physical item, comprising:
an identification tag configured to be coupled to the physical item and having a relevant tag identifier adapted to be read at a distance;
a non-fungible cryptographic token issued on a predetermined digital register distributed in a plurality of nodes of a processor network, the non-fungible cryptographic token being configured to store at least said relevant tag identifier of the identification tag coupled to the physical item and data or information representative of said physical item, said non-fungible cryptographic token forming a unique digital representation of said physical item;
detectors configured to detect a presence of said identification tag of the physical item passing nearby and to read the relevant tag identifier of said identification tag; and
a remote processing system associated with said detectors and configured to access said non-fungible cryptographic token on the basis of the relevant tag identifier acquired from said identification tag,
wherein said detectors are configured to detect the presence of said physical item in a predetermined detection area or through a predetermined detection gate, wherein said predetermined detection area or said predetermined detection gate is located in transit areas through which said physical item has to pass to be classified as an authentic item, and said remote processing system is configured to record in said non-fungible cryptographic token data indicative of the presence of the physical item in said predetermined detection area or through said predetermined detection gate.

2. The system of claim 1, wherein said predetermined detection area or said predetermined detection gate is located along an access path to an event during which said physical item is used, and recording of the presence of the physical item in the predetermined detection area or through the predetermined detection gate is adapted to correlate said physical item to said event.

3. The system of claim 2, further comprising a geographic localization system associated with said detectors and configured to localize the detectors in a predetermined geographic reference system, and to feed recording of relative location data into said non-fungible cryptographic token.

4. The system of claim 3, wherein said geographic localization system comprises satellite localization devices or terrestrial localization devices, and said remote processing system is configured to acquire data of the satellite localization devices, or of the terrestrial localization devices, respectively, used for localization and to record said data of the satellite localization devices, or of the terrestrial localization devices, respectively, in said non-fungible cryptographic token, and
wherein said data of the satellite or terrestrial localization devices used for localization are adapted to be used by said remote processing system to verify origin of the data acquired by said detectors.

5. The system of claim 2, wherein said remote processing system is configured to verify a correlation of said physical item to said event by a comparison with data referring to the event and stored in a computer system of a certification entity extraneous to the system.

6. The system of claim 1, wherein said identification tag is a tamper-proof radio-frequency identification tag integrated with the physical item.

7. The system of claim 1, wherein said identification tag is an identification tag assembly comprising a combination of a Radio Frequency Identification (RFID) microcircuit and a Near Field Communication (NFC) microcircuit, wherein the RFID microcircuit stores a unique identifier of the NFC microcircuit and the NFC microcircuit stores the unique identifier of the RFID microcircuit.

8. The system of claim 1, wherein said non-fungible cryptographic token is initialized with identification data of a manufacturer of the physical item and is configured to store data representative of transfers of ownership of said physical item, comprising at least one transfer from the manufacturer to a first buyer.

9. The system of claim 1, wherein said non-fungible cryptographic token includes a time stamp indicative of time of creation of the non-fungible cryptographic token.

10. The system of claim 1, wherein said non-fungible cryptographic token includes data indicative of a current location of the physical item.

11. The system of claim 1, wherein a graphic identification code (C) of the physical item or an identification code of the physical item stored electronically according to a predetermined format is coupled to said physical item, the identification code storing address data of the predetermined distributed digital register, the address data allowing partial read access to the data recorded in said non-fungible cryptographic token.

12. The system of claim 11, comprising a user interface computer environment, implemented as an application adapted to be downloaded and to reside on a user's personal mobile telecommunication device or on a user's personal processing device, said user interface computer environment being configured to perform said partial read access to the data recorded in said non-fungible cryptographic token on the basis of said address data.

13. The system of claim 1, wherein said predetermined distributed digital register is an Ethereum blockchain platform and said non-fungible cryptographic token is implemented as an ERC-721 token on the Ethereum blockchain platform.

14. The system of claim 1, wherein said physical item is a garment.

15. The system of claim 14, wherein the identification tag is incorporated in an area of the garment on which a heat-sealed patch is affixed.

16. A method for authenticating and certifying a physical item by the system of claim 1, the method comprising:
coupling an identification tag to the physical item, the identification tag having a relevant tag identifier adapted to be read at a distance;
issuing a non-fungible cryptographic token on a predetermined digital register distributed in a plurality of nodes of a processor network, and storing in said non-fungible cryptographic token the relevant tag identifier of the identification tag coupled to the physical item and data or information representative of the physical item, whereby said non-fungible cryptographic token forms a unique digital representation of said physical item;
detecting a presence of said identification tag of the physical item passing through a predetermined detection area or through a predetermined detection gate;
reading the relevant tag identifier of said identification tag and accessing said non-fungible cryptographic token on the basis of the relevant tag identifier acquired from the identification tag; and
recording in said non-fungible cryptographic token a data indicative of the presence of the physical item in said predetermined detection area or through said predetermined detection gate.

17. A physical item certified by the system of claim 1, comprising an identification tag having a relevant tag identifier adapted to be read at a distance, wherein a non-fungible cryptographic token issued on a predetermined digital register distributed in a plurality of nodes of a processor network is associated therewith, the non-fungible cryptographic token forming a unique digital representation of the physical item, the relevant tag identifier of the identification tag being stored in the non-fungible cryptographic token together with data or information representative of the physical item and data indicative of presence of the physical item in a predetermined detection area or through a predetermined detection gate arranged along an access path to an event during which said physical item was used.

18. The physical item of claim 17, wherein said physical item is a garment, a collectible, or a luxury item.

19. The physical item of claim 18, wherein said garment is a sportswear item.
